(19) United States
(12) Patent Application Publication
(10) Pub. No.: US 2012/0154279 A1
(43) Pub. Date: Jun. 21, 2012

(54) WIRELESS DATA TRANSMITTING SYSTEM AND METHOD THEREOF

(75) Inventor: SONG-LING YANG, Shenzhen (CN)

(73) Assignees: HON HAI PRECISION INDUSTRY CO., LTD., Tu-cheng (TW); HONG FU JIN PRECISION INDUSTRY (ShenZhen) CO., LTD ., Shenzhen City (CN)

(21) Appl. No.: 13/095,905

(22) Filed: Apr. 28, 2011

(30) Foreign Application Priority Data
Dec. 20, 2010 (CN) 201010596259.9

(51) Int. Cl. G06F 3/033

(52) U.S. Cl. 345/163

(57) ABSTRACT

A data transmitting method is provided. The data transmitting method is applied on a data transmitting system. The system includes a mouse and electronic devices. The mouse includes a first wireless communication unit. Each electronic device includes a second wireless communication unit. The mouse periodically determines that one electronic device nearest to the mouse is the to-be-operated electronic device. After the operation mode of the mouse is has been changed to data transmitting mode, the mouse determines the function of the electronic device according to a movement pattern of a cursor.

### BACKGROUND

1. Technical Field

The present disclosure relates to data transmitting systems and methods and, particularly, to a wireless data transmitting system and a method thereof.

2. Description of Related Art

Nowadays, a wired mouse providing a data storage is commonly used to transmit data between electronic devices. For transmitting data, a wired mouse is first connected to a first electronic device to obtain desired data, and is then connected to a second electronic device to transmit the desired data to the second electronic device. If more electronic devices need the desired data, using the wired mouse for transmitting data is inconvenient.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a data transmitting system in accordance with an exemplary embodiment.

FIG. 2 is a block diagram of the data transmitting system of FIG. 1 in accordance with an embodiment.

FIG. 3 is a flowchart of a data transmitting method in accordance with an exemplary embodiment.

### DETAILED DESCRIPTION

Embodiments of the present disclosure are now described in detail, with reference to the accompanying drawings.

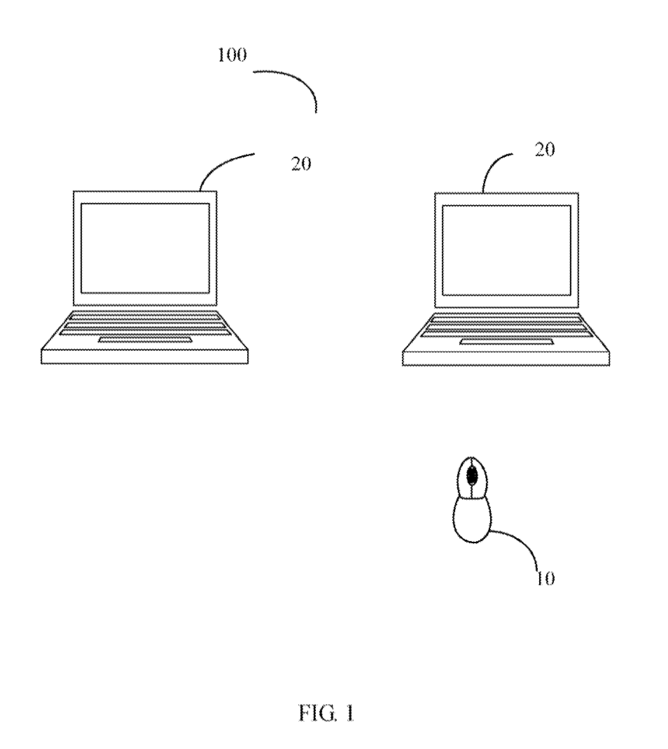

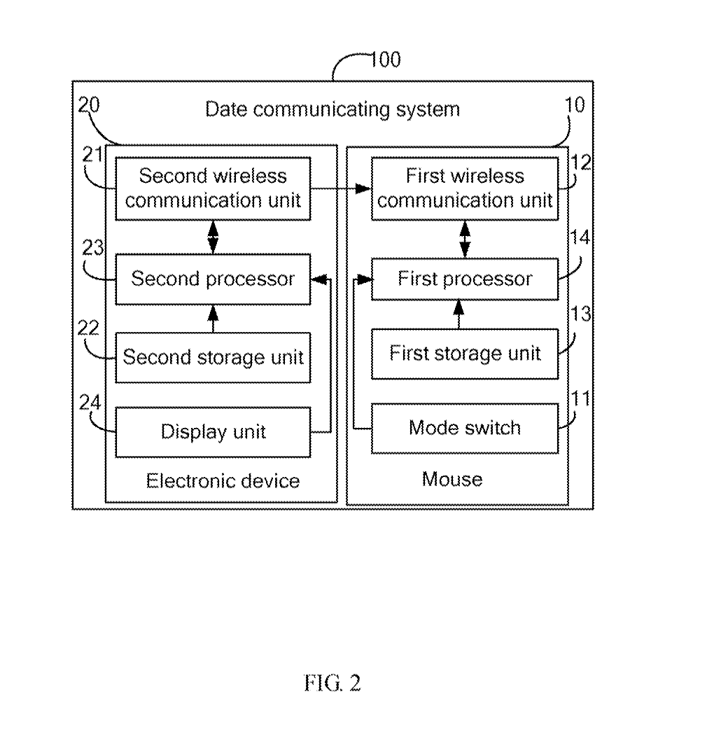

Referring to FIGS. 1-2, a data transmitting system 100 includes a mouse 10 and a number of electronic devices 20. The mouse 10 can be employed as a conventional mouse to operate the electronic devices 20, and can further be employed to transmit data between the electronic devices 20. In the embodiment, each electronic device 20 is a computer.

The mouse 10 includes a mode switch 11, a first wireless communication unit 12, a first storage unit 13, and a first processor 14. Each electronic device 20 includes a second wireless communication unit 21, a second storage unit 22, and a second processor 23.

The mode switch 11 switches operation modes of the mouse 10 between a normal operation mode and a data transmitting mode in response to user operation. In the normal operation mode, the mouse 10 is employed as a conventional mouse to operate the electronic devices 20.

The mouse 10 communicates with the electronic devices 20 when the distance between the first wireless communication unit 12 and the second wireless communication unit 20 is within a preset range. In the embodiment, the first wireless communication unit 12 and the second wireless communication units 21 are WI-FI units or BLUETOOTH units.

The first processor 14 periodically transmits an activation signal to each electronic device 20 through the first wireless communication unit 12 and the second wireless communication 21. Upon receiving the activation signal from the mouse 10, the second processor 23 transmits an identification code of the electronic devices 20 to the mouse 10 through the second wireless communication unit 21 and the first wireless communication unit 12. The first processor 14 determines that the mouse 10 is employed to operate the electronic device 20 whose identification code is first received by the mouse 10. In this embodiment, the identification code of the electronic device 20, which is nearest to the mouse 10, is first received by the mouse 10. That is, the mouse 10 is employed to operate the electronic device 20 which is nearest to the mouse 10. Therefore, a user can conveniently select a to-be-operated electronic device 10 by moving the mouse 10 close to the desired device.

After a to-be-operated electronic device 10 is determined, the operation mode of the mouse 10 can be switched by operating the mode switch 11. In an alternative embodiment, the operation mode of the mouse 10 can be switched by operating the mode switch 11 before the to-be-operated electronic device 10 is determined. Under the normal operation mode, the mouse 10 can be employed as the conventional mouse to operate the determined electronic device 20. Under the data transmitting mode, the determined electronic device 20 can transmit data to the mouse 10 or obtain data from the mouse 10.

The second storage unit 22 stores a table. The table includes a first column recording movement patterns of a displayed cursor and a second column recording a to-be-executed function of the electronic device 20. Each movement pattern of the displayed cursor corresponds to the to-be-executed function. In the embodiment, the to-be-executed function of the electronic device 20 includes transmitting a selected document to the mouse 10 and obtaining a recently saved document from the mouse 10. For example, in the first embodiment, dragging the cursor to the left in a determined radian is defined as the function of transmitting a selected document to the mouse 10, and dragging the cursor to the right in a determined radian is defined as the function of obtaining a recently saved document from the mouse 10.

Under the data transmitting mode, when a document is clicked, the second processor 23 determines that the clicked document is a selected document. When the mouse 10 is moved to drag the cursor to the left in a determined radian, the second processor 23 determines that the to-be-executed function is transmitting a selected document to the mouse 10, and the second processor 23 transmits the selected document to the mouse 10 to store in the first storage unit 13. When the mouse 10 is moved to be close to another electronic device 20, the first processor 14 determines that the other electronic device 20 is the to-be-operated electronic device 20. When the mouse 10 is moved to drag the cursor to the right in a determined radian, the second processor 23 determines that the to-be-executed function is obtaining a recently saved document from the mouse 10. The second processor 23 transmits a transmitting signal to the mouse 10 through the second wireless communication unit 21 and the first wireless communication unit 12. The first processor 14 transmits the recently received document stored in the first storage unit 13 from the mouse 10 to the to-be-operated electronic device 20 through the first wireless communication unit 12 and the second wireless communication unit 21 according to the transmitting signal.

In the second embodiment, each electronic device 20 further includes a display unit 24. Dragging the cursor moving to a boundary of the display unit 24 is defined as the function of transmitting a selected document to the mouse 10, and dragging the cursor moving from the boundary to a non-boundary of the display unit 24 is defined as the function of obtaining a recently saved document from the mouse 10. Because the determining process of the to-be-executed function is the same as that of the first embodiment described above, except for what is described below, so the detailed description thereof is omitted.

When the mouse 10 is moved to drag the cursor moving to the boundary of the display unit 24, the second processor 23 determines that the to-be-executed function is transmitting a selected document to the mouse 10. When the mouse 10 is moved to drag the cursor moving from the boundary to the non-boundary of the display unit 24, the second processor 23 determines that the to-be-executed function is obtaining the recently saved document from the mouse 10.

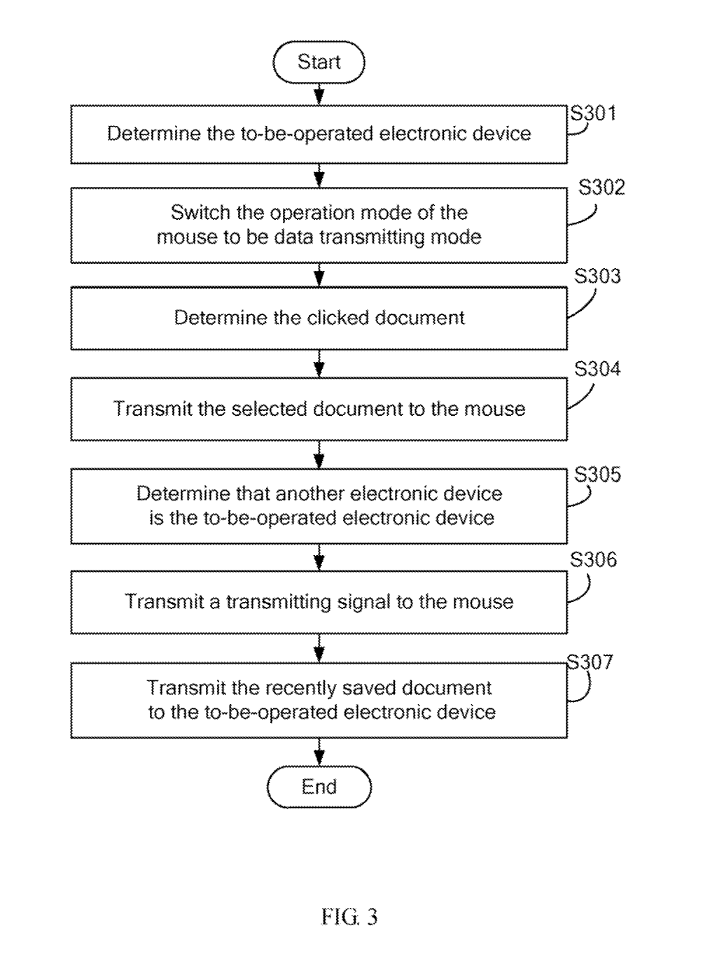

Referring to FIG. 3, a flowchart of a data transmitting method in accordance with an exemplary embodiment is shown.

In step S301, the first processor 14 periodically determines which electronic device 20 is operated by the mouse 10. In the embodiment, the first processor 14 periodically transmits an activation signal to the electronic devices 20 through the first wireless communication unit 12 and the second wireless communication unit 21. The second processor 23 transmits an identification code of the electronic devices 20 to the mouse 10 through the second wireless communication unit 21 and the first wireless communication unit 12. The first processor 14 determines that the mouse 10 is employed to operate the electronic device 20 whose identification code is first received by the mouse 10.

In step S302, the first processor 14 switches the operation mode of the mouse 10 to the data transmitting mode in response to the operation of the user on the mode switch 11. In an alternative embodiment, the first processor 14 switches the operation mode of the mouse 10 to the data transmitting mode before the to-be-operated electronic device 10 is determined.

In step S303, the second processor 23 determines that the clicked document is the selected document.

In step S304, the second processor 23 determines the movement pattern of a display cursor and executes a corresponding function according to the determined movement pattern and the table. When the second processor 23 determines the movement pattern of the cursor corresponding to the function of transmitting a document to the mouse 10, the second processor 23 transmits the selected document to the mouse 10 through the second wireless communication unit 21 and the first wireless communication unit 12. In the first embodiment, the second processor 23 transmits the selected document to the mouse 10 when the second processor 23 determines that the cursor is dragged to the left in a determined radian. In the second embodiment, the second processor 23 transmits the selected document to the mouse 10 when the second processor 23 determines that the cursor is dragged to a boundary of the display unit 24.

In step S305, the first processor 14 determines that another electronic device 20 is the to-be-operated electronic device 20 when the mouse 10 is moved near the other electronic device 10.

In step S306, the second processor 23 determines the movement patterns of the display cursor, and executes a corresponding function according to the movement patterns of the display cursor and the table. When the second processor 23 determines the movement pattern of the cursor corresponding to the function of obtaining a recently saved document from the cursor, the second processor 23 transmits a transmitting signal to the cursor through the second wireless communication unit 21 and the first wireless communication unit 12. In the first embodiment, the second processor 23 transmits a transmitting signal to the cursor when the second processor 23 determines that the cursor is dragged to the right in a predetermined radian. In the second embodiment, the second processor 23 transmits a transmitting signal to the mouse 10 when the second processor 23 determines that the cursor is dragged from the boundary to the non-boundary of the display unit 24.

In step S307, the first processor 14 transmits the recently saved document to the to-be-operated electronic device 20 through the first wireless communication unit 12 and the second wireless communication unit 21.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A data transmitting system comprising:
a mouse comprising:
a first wireless communication unit; and
a first processor; and
a plurality of electronic devices, each of which comprises:
a second wireless communication unit to communicate with the first wireless communication unit when a distance between the first wireless communication unit and the second wireless communication is within a preset range;
a second processor to determine a movement pattern of a cursor and executing a corresponding function according to the determined movement pattern of a cursor after the operation mode of the mouse is switched to a data transmitting mode;
wherein the first processor periodically determines that one of the electronic devices nearest the mouse is the to-be-operated electronic device.

2. The data transmitting system as described in claim 1, wherein the first processor periodically transmits an activation signal to each of the electronic devices through the first wireless communication unit and each of the second wireless communications, the second processors transmit an identification code to the mouse through each of the second wireless communication units and the first wireless communication unit, and the first processor determines that the mouse operates the electronic device whose identification code is firstly received by the mouse.

3. The data transmitting system as described in claim 1, wherein the second processor transmits a selected document to the mouse through the second wireless communication unit and the first wireless communication unit when the second processor determines that the movement pattern of a cursor corresponds to the function of transmitting the selected document to the mouse.

4. The data transmitting system as described in claim 1, wherein the second processor transmits a transmitting signal to the mouse through the second wireless communication unit and the first wireless communication unit when the second processor determines that the movement pattern of the cursor corresponds to the function of obtaining the recently document from the mouse, the first processor transmits the recently saved document to the to-be-operated electronic device through the first wireless communication unit and the second wireless communication unit.

5. The data transmitting system as described in claim 3, wherein each of the electronic devices comprises a storage unit storing a table recording movement patterns of the cursor and the functions of each of the electronic devices, each of the movement patterns of the cursor corresponds to one of the functions of each of the electronic devices, the second processor determines the functions of the each of the electronic devices according to the table and the determined movement patterns of the cursor.

6. The data transmitting system as described in claim 5, wherein dragging the cursor to the left in a predetermined radian is defined as the function of transmitting a selected document to the mouse in the table.

7. The data transmitting system as described in claim 5, wherein each of the electronic devices further comprises a display unit, dragging the cursor to a boundary of the display unit is defined as the function of transmitting the selected document to the mouse in the table.

8. The data transmitting system as described in claim 4, wherein each of the electronic devices comprises a storage unit storing a table recording movement patterns of the cursor and the functions of each of the electronic devices, each of the movement patterns of the cursor corresponds to one of the functions of each of the electronic devices, the second processor determines the functions of the each of the electronic devices according to the table and the determined movement patterns of the cursor.

9. The data transmitting system as described in claim 8, wherein dragging the cursor to the right in a predetermined radian is defined as the function of obtaining the recently saved document from the mouse in the table.

10. The data transmitting system as described in claim 8, wherein each of the electronic devices further comprises a display unit, dragging the cursor from the boundary to the non-boundary of the display unit is defined as the function of obtaining the recently saved document from the mouse in the table.

11. A data transmitting method applied on a data transmitting system, the system comprising a mouse and a plurality of electronic devices, the mouse comprising a first wireless communication unit, each of the electronic devices comprising a second wireless communication unit communicating with the first wireless communication unit, the method comprising:
determining that one of the electronic devices nearest to the mouse is the to-be-operated electronic device periodically; and
determining a movement pattern of a cursor and executing a corresponding function according to the determined movement pattern of a cursor after the operation mode of the mouse is switched to a data transmitting mode.

12. The data transmitting method as described in claim 11, wherein the method comprises:
transmitting an activation signal to each of the electronic devices periodically through the first wireless communication unit and each of the second wireless communication units;
transmitting an identification code to the mouse through each of the second wireless communication units and the first wireless communication unit; and
determining that the mouse is used to operate the electronic device whose identification code is firstly received by the mouse.

13. The data transmitting method as described in claim 11, wherein the method comprises:
the second processor transmits a selected document to the mouse through the second wireless communication unit and the first wireless communication unit when the second processor determines that the movement pattern of a cursor corresponds to the function of transmitting the selected document to the mouse.

14. The data transmitting method as described in claim 11, wherein the method comprises:
the second processor transmits a transmitting signal to the mouse through the second wireless communication unit and the first wireless communication unit when the second processor determines that the movement pattern of the cursor corresponds to the function of obtaining the recently document from the mouse; and
the first processor transmits the recently saved document to the to-be-operated electronic device through the first wireless communication unit and the second wireless communication unit.

15. The data transmitting method as described in claim 13, wherein each of the electronic devices comprises a storage unit storing a table recording movement patterns of the cursor and the functions of each of the electronic devices, each of the movement patterns of the cursor corresponds to one of the function of each of the electronic devices, the method comprises:
determining the function of the each of the electronic devices according to the table and the determined movement patterns of the cursor.

16. The data transmitting method as described in claim 15, wherein dragging the cursor to the left in a predetermined radian is defined as the function of transmitting a selected document to the mouse in the table.

17. The data transmitting method as described in claim 15, wherein each of the electronic devices further comprises a display unit, dragging the cursor to a boundary of the display unit is defined as the function of transmitting the selected document to the mouse in the table.

18. The data transmitting method as described in claim 14, wherein each of the electronic devices comprises a storage unit storing a table recording movement patterns of the cursor and the functions of each of the electronic devices, each of the movement patterns of the cursor corresponds to one of the function of each of the electronic devices, the method comprises:
determining the function of the each of the electronic devices according to the table and the determined movement patterns of the cursor.

19. The data transmitting method as described in claim 18, wherein dragging the cursor to the right in a predetermined radian is defined as the function of obtaining the recently saved document from the mouse in the table.

20. The data transmitting method as described in claim 18, wherein each of the electronic devices further comprises a display unit, dragging the cursor from the boundary to the non-boundary of the display unit is defined as the function of obtaining the recently saved document from the mouse in the table.
